(19) United States
(12) Patent Application Publication
(10) Pub. No.: US 2026/0042095 A1
(43) Pub. Date: Feb. 12, 2026

(54) CONCENTRATION, EXTRACTION AND IDENTIFICATION SYSTEM AND A MICROFLUIDIC CHIP READING INSTRUMENT FOR THAT SYSTEM

(71) Applicant: University of Kentucky Research Foundation, Lexington, KY (US)

(72) Inventors: Scott Berry, Lexington, KY (US); Soroosh Torabi, Lexington, KY (US); William Dalton Strike, Lexington, KY (US); Mohammad Dehgham Banadki, Lexington, KY (US); Anni Noble, Lexington, KY (US)

(21) Appl. No.: 19/297,439

(22) Filed: Aug. 12, 2025

Related U.S. Application Data
(60) Provisional application No. 63/682,283, filed on Aug. 12, 2024.

(51) Int. Cl. B01L 3/00; B01L 7/00

(52) U.S. Cl. CPC B01L 3/502761; B01L 7/52; B01L 2200/16; B01L 2300/0609; B01L 2300/0819; B01L 2300/1827

(57) ABSTRACT

A concentration, extraction and identification system (CEIS) for microbiological analysis of a biological sample, includes: (1) a plurality of paramagnetic particles adapted to bind to a nucleic acid fraction of a targeted biological pathogen, (2) a microfluidic chip including a plurality of interconnected wells; and (3) a microfluidic chip reading instrument including a housing carrying (a) a microfluidic chip receiver adapted to hold the microfluidic chip and (b) a magnet and actuator adapted to displace the plurality of paramagnetic particles from a biological sample well through a first isolation buffer well, a wash well, and a second isolation buffer well to an elution well.

### RELATED APPLICATION

This application claims the benefit of U.S. Provisional Patent Application Ser. No. 63/682,283 filed on Aug. 12, 2024, the entirety of which is incorporated herein by reference.

### STATEMENT REGARDING FEDERALLY SPONSORED RESEARCH OR DEVELOPMENT

This invention was made with government support under Grant Nos. 1U01DA053901-01 and P30 ES026529 awarded by the National Institute of Health (NIH), Contract No. BAA 75D301-20-R-68024 awarded by the Centers for Disease Control and Prevention (CDC), and Grant Nos. 2154934 and 2412446 awarded by the National Science Foundation (NSF). The government has certain rights in the invention.

### REFERENCE TO SEQUENCE LISTING SUBMITTED ELECTRONICALLY

A sequence listing electronically submitted with the present application as an XML file named 13177N-2959.xml, created on Aug. 5, 2025 and having a size of 11,783 bytes, is incorporated herein by reference in its entirety.

### TECHNICAL FIELD

This document relates generally to a system for collecting, extracting, and identifying a nucleic acid fraction of a targeted biological pathogen and, more particularly to detecting low prevalence pathogens in an environmental sample.

### BACKGROUND

Surveillance of emerging infectious diseases is essential for implementing preventive and control strategies during outbreaks; this surveillance is often performed using clinical testing of individuals. However, large-scale clinical testing to track infectious diseases within populations is resource-intensive and expensive. Wastewater-based epidemiology (WBE) tracks the prevalence of pathogens in a community via regular wastewater testing. WBE is a powerful public health tool that can act as an early warning system and inform health officials about the spread of infectious diseases in a community and allocation of resources in an outbreak.

During the COVID-19 pandemic, WBE provided valuable information on SARS-CoV-2 and infection rates in rural and urban settings such as university dormitories, nursing homes, wastewater treatment plants, and others. Beyond SARS-CoV-2, WBE can measure the emergence/presence/abundance of different viruses (e.g., influenza, mpox), bacteria (e.g., E. coli, V. cholerae, antibiotic-resistant strains), fungi (e.g., C. auris), and other biological markers indicative of disease. Unfortunately, WBE implementation has been inequitable, with disproportionate utilization at large cities' municipal wastewater treatment plants and limited application in low-resource and rural locations. WBE can be particularly useful in low-resource settings where access to health care is limited, and individual clinical testing faces logistical challenges.

WBE minimizes the cost of disease monitoring at a population level compared to traditional clinical testing. However, widespread adoption of WBE in low-resource settings is hindered by the lack of infrastructure, limited technical capacity, and the need for trained personnel. Those limitations are seen at almost every step of the WBE workflow (See FIG. 1). Wastewater samples are collected using sampling methods from either a sewage manhole, pit latrine, lagoon, or wastewater treatment plant and are stored and transported to a central laboratory in sterile containers at refrigerated temperatures. However, the maintenance of the cold chain storage, especially for long travel distances in remote areas, is often compromised, facilitating degradation of the nucleic acids in the wastewater sample. Stabilization techniques have been shown to mitigate this degradation, and our group has previously demonstrated that nucleic acid extraction provides significant stabilization, even at room temperature.

Moreover, wastewater samples are usually highly diluted due to rainfall, agricultural run-off, and industrial and non-excrement wastewater. This results in low and even undetectable concentrations of nucleic acid in wastewater samples. Therefore, a concentration step is also recommended to achieve reliable signals. Common concentration methods such as polyethylene glycol precipitation, ultrafiltration, and ultracentrifugation are widely used in (and limited to) centralized laboratories. Those methods require long processing times (>90 mins), and expensive equipment such as ultracentrifugation systems and vacuum pumps and are followed by a separate extraction step that adds to the time and cost per sample.

Solid-phase extraction and magnetic bead-based extraction are commonly used to isolate nucleic acid from wastewater samples. However, the cost and complexity of those methods and the need for trained staff remain a huge barrier to the adoption in low-resource settings. The final step is to identify and quantify the isolated nucleic acids using an amplification method or sequencing techniques. The commonly used polymerase chain reaction (PCR) method needs a thermal cycler and typically takes more than one hour to complete. Therefore, there is a need for an easy-to-use and inexpensive concentration, extraction, and identification workflow that is suitable for WBE applications in low-resource settings. Such a point-of-use wastewater testing device could revolutionize WBE, in the same way point-of-care (POC) testing has revolutionized clinical testing.

This document relates to a novel Concentration-Extraction-Identification System (CEIS) that employs:
(a) a microfluidic chip that relies upon immiscible filtration assisted by surface tension (IFAST) for nucleic acid extraction and colorimetric reverse transcription loop-mediated isothermal amplification (RT-LAMP) for pathogen detection; and
(b) a cooperating microfluidic chip reading instrument that simplifies the chip reading process so that one with minimal training may easily implement wastewater-based epidemiology in low-resource settings with infrastructure limitations.

### SUMMARY

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “an oil”, as used herein, may also refer to, and encompass, a plurality of oils.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

In accordance with the purposes and benefits set forth herein, a new and improved concentration, extraction and identification system (CEIS) for microbiological analysis of a biological sample, comprises, consists of or consists essentially of:
(1) a plurality of paramagnetic particles adapted to bind to a nucleic acid fraction of a targeted biological pathogen;
(2) a microfluidic chip including (a) a biological sample well adapted to receive a mixture of the wastewater sample, the plurality of paramagnetic particles and a lysis buffer, (b) a first isolation buffer well downstream from the biological sample well, (c) a wash well downstream from the first isolation buffer well, (d) a second isolation buffer well downstream from the wash well, and (e) an elution well downstream from the second isolation buffer well; and
(3) a microfluidic chip reading instrument including a housing carrying (a) a microfluidic chip receiver adapted to hold the microfluidic chip and (b) a magnet and actuator adapted to displace the plurality of paramagnetic particles from the biological sample well through the first isolation buffer well, the wash well, and the second isolation buffer to the elution well.

In one or more of the many possible embodiments of the CEIS, the microfluidic chip reading instrument further includes a heating element adapted to heat amplification reagents and the plurality of paramagnetic particles in the elution well.

The microfluidic chip reading instrument and CEIS may further include a controller carried on the housing, wherein the controller is adapted to control the actuator and the heating element. The microfluidic chip reading instrument and CEIS may further include a power source, such as a battery, carried on the housing, wherein the power source is adapted for powering the controller, the actuator and the heating element.

In some embodiments of the microfluidic chip reading instrument and the CEIS, the housing may further include a cell phone receiver adapted to receive and hold a cell phone. In some embodiments of the microfluidic chip reading instrument and the CEIS, the housing further includes a camera window oriented to be positioned between a camera lens on the cell phone and the elution well of the microfluidic chip when the cell phone is properly seated in the cell phone receiver and the microfluidic chip is properly seated in the microfluidic chip receiver.

The microfluidic chip reading instrument and the CEIS may further include a system status indicator, such as one or more light emitting diodes (LEDs), carried on the housing. In such embodiments, the controller may be adapted to control the system status indicator. The microfluidic chip reading instrument and the CEIS may further include an actuator switch carried on the housing allowing one to turn on the controller for testing or turn off the controller to save battery power.

In accordance with yet another aspect, a new and improved microfluidic chip reading instrument, adapted to receive and hold a microfluidic chip for concentration, extraction and identification of a nucleic acid fraction of a targeted biological pathogen, comprises, consists of or consists essentially of a housing including (a) a microfluidic chip receiver adapted to receive and hold the microfluidic chip and (b) a cell phone receiver adapted to receive and hold a cell phone.

The microfluidic chip reading instrument may further include a magnet and actuator carried on the housing. The magnet and actuator may be adapted to displace a plurality of paramagnetic particles between a plurality of wells in the microfluidic chip. The microfluidic chip reading instrument may further include a heating element carried on the housing. The heating element may be adapted to heat loop-mediated isothermal amplification reagents and the plurality of paramagnetic particles in an elution well in the microfluidic chip.

The microfluidic chip reading instrument may further include a controller carried on the housing. The controller may be adapted to control the actuator and the heating element. The microfluidic chip reading instrument may further include a power source carried on the housing, wherein the power source is adapted for powering the controller, the actuator and the heating element.

The housing may further include a camera window oriented to be positioned between a camera lens on the cell phone and the elution well in the microfluidic chip when the cell phone is properly seated in the cell phone receiver and the microfluidic chip is properly seated in the microfluidic chip receiver.

The microfluidic chip reading instrument may further include (a) a light source adapted to illuminate the elution well in the microfluidic chip, (b) a system status indicator carried on the housing, and (c) an actuator switch carried on the housing. In such an embodiment, the controller is further adapted to control the light source and the system status indicator.

In accordance with yet another aspect, a microfluidic chip reading instrument, adapted to receive and hold a microfluidic chip for concentration, extraction and identification of a nucleic acid fraction of a targeted biological pathogen, comprises, consists of or consists essentially of (a) a housing including a microfluidic chip receiver adapted to receive and hold the microfluidic chip and (b) a magnet and actuator carried on the housing, said magnet and actuator being adapted to displace a plurality of paramagnetic particles between a plurality of wells in the microfluidic chip.

The microfluidic chip reading instrument may further include a heating element carried on the housing. The heating element may be adapted to heat amplification reagents and the plurality of paramagnetic particles in an elution well in the microfluidic chip. The microfluidic chip reading instrument may further include a controller carried on the housing, wherein the controller is adapted to control the actuator and the heating element. The microfluidic chip reading instrument may further include a power source carried on the housing, wherein the power source is adapted for powering the controller, the actuator and the heating element.

The housing may further include a camera window oriented to be positioned between a camera lens on the cell phone and the elution well in the microfluidic chip when the cell phone is properly seated in the cell phone receiver and the microfluidic chip is properly seated in the microfluidic chip receiver. The microfluidic chip reading instrument may further include (a) a light source adapted to illuminate the elution well in the microfluidic chip, (b) a system status indicator carried on the housing, and (c) an actuator switch carried on the housing. In such an embodiment, the controller is further adapted to control the light source and the system status indicator.

In accordance with yet another aspect, a method of wastewater surveillance using an integrated microfluidic chip, comprises, consists of or consists essentially of.
(1) adding a wastewater sample, a lysis buffer and a plurality of magnetic particles into a wastewater sample well of the integrated microfluidic chip;
(2) positioning the integrated microfluidic chip on a microfluidic chip receiver of a microfluidic chip reading instrument; and
(3) positioning a cell phone on a cell phone receiver of the microfluidic chip reading instrument.

The method may further include activating the microfluidic chip reading instrument. The method may further include displacing the plurality of paramagnetic particles between a plurality of wells in the microfluidic chip from the wastewater sample well to an elution well using a magnet and actuator carried on the microfluidic chip reading instrument.

The method may further include heating amplification reagents and the plurality of paramagnetic particles in the elution well using a heating element carried on the microfluidic chip reading instrument. The method may further include tracking color change of the reagents in the elution well with a camera of the cell phone. The method may further include illuminating the elution well with a light source carried on the microfluidic chip reading instrument when the tracking the color change of the reagents in the elution well with the camera of the cell phone.

In the following description, there are shown and described several different embodiments of (a) the CEIS, (b) the microfluidic chip reading instrument, and (c) the related method of wastewater surveillance using an integrated microfluidic chip. As it should be realized, the system, instrument and the related methods are capable of other, different embodiments and their several details are capable of modification in various, obvious aspects all without departing from the system, instrument and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the CEIS, the instrument and the related method and together with the description serve to explain certain principles thereof. A person of ordinary skill in the art will readily recognize from the following discussion that alternative embodiments of the system, instrument and the related method may be employed without departing from the principles described below.

FIG. 1 is a schematic illustration of the steps of conventional water-based epidemiology workflow and its limitations.

FIG. 2 is a perspective view of one possible embodiment of a microfluidic chip including (a) a biological sample well adapted to receive a mixture of the waste water sample, the plurality of paramagnetic particles and a lysis buffer, (b) a first isolation buffer well downstream from the biological sample well, (c) a wash well downstream from the first isolation buffer well, (d) a second isolation buffer well downstream from the wash well, and (e) an elution well downstream from the second isolation buffer well.

FIGS. 3A-3C are schematic illustrations of the microfluidic chip reading instrument and its use in reading the microfluidic chip illustrated in FIG. 2.

FIG. 4 is a schematic representation of the electronic control system provided on the microfluidic chip reading instrument.

FIG. 5 is a schematic illustration of the immiscible filtration assisted by surface tension (IFAST) between wells that allows the paramagnetic particles to move through the wells while preventing liquid transfer between wells.

FIGS. 6A-6D are graphs illustrating wastewater surveillance of SARS-CoV-2 for two locations in a six week period with (a) FIG. 6A illustrating replicate positivity for Location A (Kendall's Tau=0.64, p-value<0.05), (b) FIG. 6B illustrating replicate positivity for Location B (Kendall's Tau=0.79, p-value<0.001), (c) FIG. 6C illustrating RT-LAMP Ct for Location A (Kendall's Tau=−0.64, p-value<0.05), and (d) FIG. 6D illustrating RT-LAMP Ct for Location B (Kendall's Tau=−0.64, p-value<0.05).

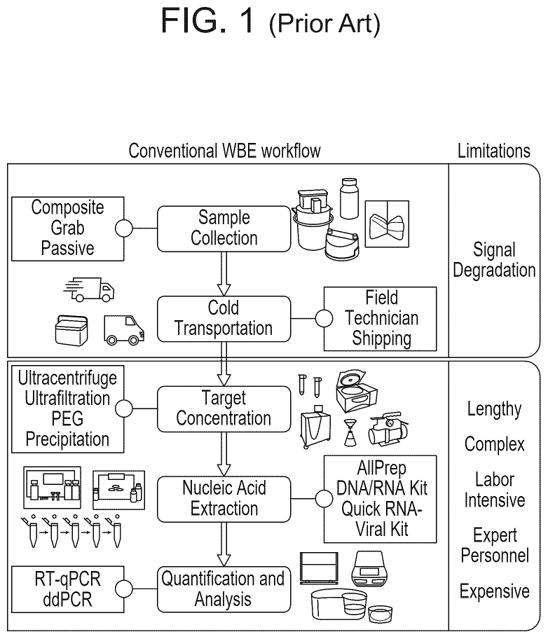

### DETAILED DESCRIPTION

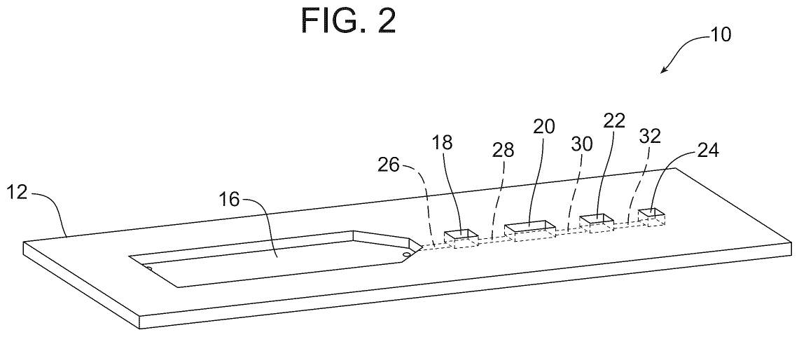

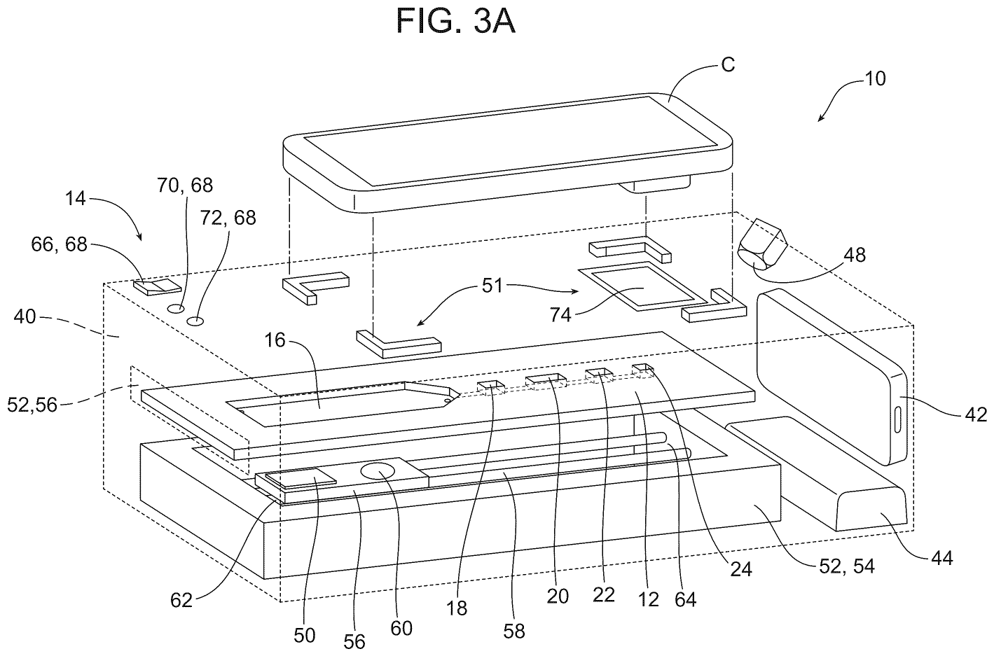

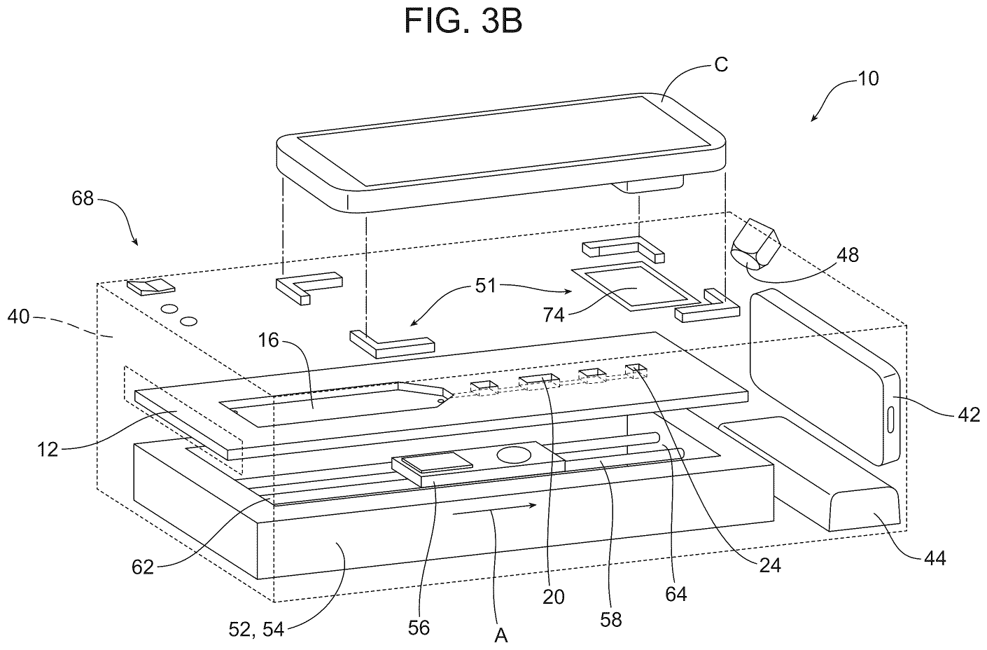

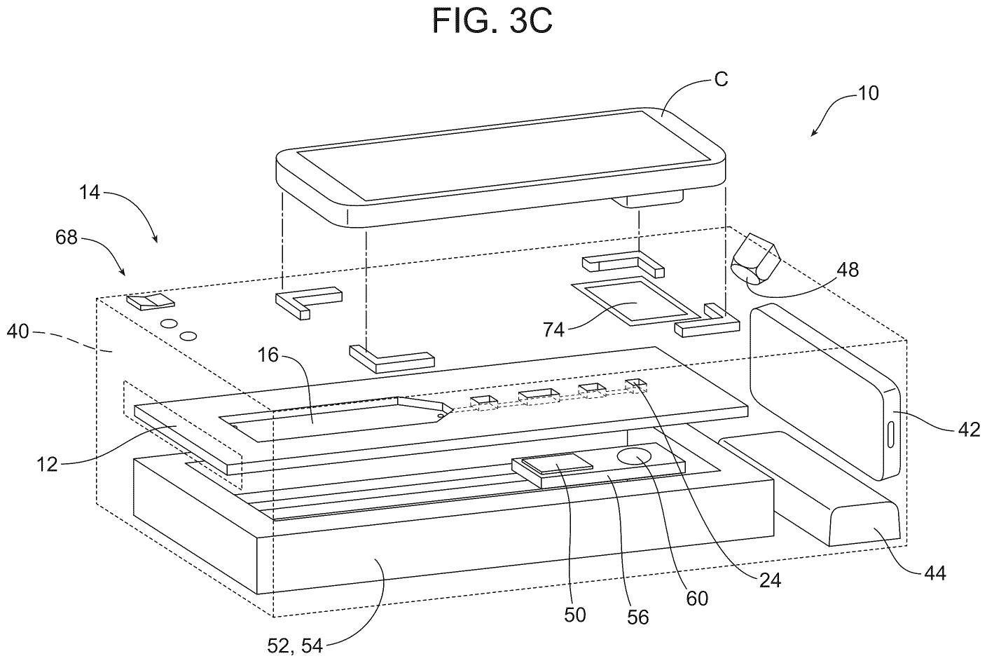

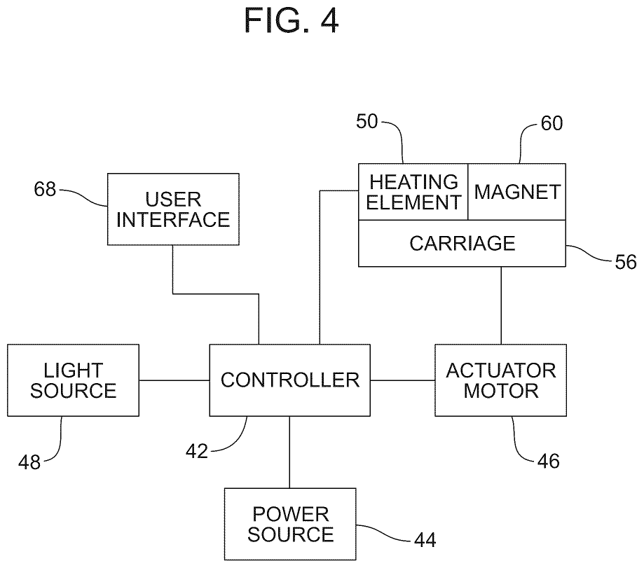

Reference is now made to FIGS. 2, 3A-3C, and 4 which taken together, illustrate the new concentration, extraction and identification system (CEIS) 10. More specifically, FIG. 2 is a detailed view of the microfluidic chip 12 of the system 10 and FIGS. 3A-3C are a series of views illustrating how the chip 12 of FIG. 2 is received in the microfluidic chip reading instrument 14 and how that chip is processed by the instrument while FIG. 4 illustrates the electronic control system of the microfluidic chip reading instrument.

In one possible embodiment, the chip 12 has a body fabricated out of 3.175 mm thick polymethyl methacrylate (PMMA) sheets using a carbon dioxide laser cutter. Of course, other fabrication methods may be used, such as 3D printing. Pressure sensitive adhesive films may enclose the chip 12. Such films may be made from polyester film or any optically clear film with pressure sensitive adhesive that did not otherwise interfere with the assay. As fabricated, the chip 12 may include: (a) a biological sample well 16, (b) a first isolation buffer well 18 downstream from the biological sample well, (c) a wash well 20 downstream from the first isolation buffer well, (d) a second isolation buffer well 22 downstream from the wash well, and (e) an elution well 24 downstream from the second isolation buffer well.

A first communication channel 26 provides fluid communication between the biological sample well 16 and the first isolation buffer well 18. A second communication channel 28 provides fluid communication between the first isolation buffer well 18 and the wash well 20. A third communication channel 30 provides fluid communication between the wash well 20 and the second isolation buffer well 22. Finally, a fourth communication channel 32 provides fluid communication between the second isolation buffer well and the elution well 24.

In use, the biological sample well 16 is loaded with the biological sample, a plurality of paramagnetic particles P and a lysis buffer. In the illustrated embodiment, the biological sample is a wastewater sample, and the system is used in a method of water surveillance. It should be appreciated, however, that other types of biological samples may be processed with the system 10, including, but not necessarily limited to other environmental samples, cultured cell samples, clinical samples, tissue samples and virus samples.

The plurality of paramagnetic particles are of a type known in the art that are silica-coated and adapted to bind to a nucleic acid fraction of a targeted biological pathogen and be attracted to a magnetic field. The lysis buffer is also of a type known in the art and adapted to break open cells and release the contents thereof including identifiable nucleic acid fractions of those cells. In one possible embodiment, the lysis buffer includes guanidine thiocyanate and 4-morpholine-thanesulfonic acid sodium salt in a solvent of ethanol and deionized water and a non-ionic surfactant such as Tween 20.

The two isolation buffer wells 18 and 22 may be loaded with a silicone oil with a viscosity of 1000 cSt or other appropriate liquid materials adapted to act as a barrier to flowing of the buffer between wells. The wash well 20 may be loaded with nuclease-free water. The elusion well 24 may be loaded with nuclease-free water and loop-mediated isothermal amplification (LAMP) reagents, of a type known in the art and adapted to provide amplification to any nucleic acid fractions of the targeted biological pathogen. In other possible embodiments, other amplification chemistries, including polymerase chain reaction (PCR), recombinase polymerase amplification (RPA), or clustered regularly interspaced short palindromic repeats (CRISPR) may be used.

FIGS. 3A-3C and 4 illustrate the microfluidic chip reading instrument 14 used to process the biological sample/wastewater sample added to the chip 12. As shown, the instrument 14 includes a housing 40. The housing 40 holds or carries, a controller 42, a power source 44, an actuator drive motor 46, a light source 48, and a resistive heating element 50. The controller 42 may comprise a dedicated microprocessor or electronic control unit (ECU) operating in accordance with instructions from an appropriate control software. The power source 44 may comprise a battery. The actuator drive motor 46 may comprise an electric motor powered by the battery 44 and is under the control of the controller 42. The light source 48, the resistive heating element 50, and the user interface 68, described below, are also under the control of the controller 42. See FIG. 4.

The housing 40 also includes (a) a cell phone receiver 51, adapted to receive and hold a cell phone C and (b) a microfluidic chip receiver 52 adapted to receive and hold the microfluidic chip 12 shown in FIG. 2 and described above. In the illustrated embodiment, the chip receiver 52 includes the chip stage 54 and the access opening 56 in the side of the housing 40. In operation, one slides the chip 12, preloaded with the biological or wastewater sample through the access opening 56 and, when fully inserted, the chip 12 is seated above the chip stage 54.

The chip stage 54 includes a carriage 56 that is displaceable along a linear guideway 58. The carriage 56 is equipped with a magnet 60 and the resistive heating element 50. As illustrated in FIGS. 3A-3C, the controller 42 functions, through controlled operation of the actuator drive motor 46, to displace the carriage 56, and the magnet 60 and resistive heating element 50 carried thereon, from a first or left end 62 of the linear guideway 58 to a second or right end 64 of the of the linear guideway. This may be accomplished in any suitable manner known to those skilled in the art. For example, the actuator drive motor 46 may be mounted to the carriage 56 and drive a pinion (not shown) that engages a stationary rack (not shown) extending along the linear guideway 58. In this way, the magnet 60 and actuator drive motor 46 are adapted to displace the plurality of paramagnetic particles P sequentially from the biological sample well/wastewater sample well 16 through the first communication channel 26 to the first isolation well 18, and then though the second communication channel 28 to the wash well 20, then through the third communication channel 30 to the second isolation well 22, and finally, through the fourth communication channel 32 to the elution well 24.

More specifically, the method of wastewater surveillance using the chip 12 includes the step of adding a previously agitated mixture of the wastewater sample, a lysis buffer and a plurality of magnetic particles P to the wastewater sample well 16 of the chip 12. The lysis buffer lyses any biological cells in the wastewater sample, releasing the contents thereof including identifiable nucleic acid fractions of those cells. Those nucleic acid fractions then bind to the silica coating on the plurality of magnetic particles P in the wastewater sample well 16. One would also add the necessary reagents, described above, to the other wells 18, 20, 22 and 24 if not already preloaded.

The chip 12 is then positioned on the chip receiver 52 by inserting through the access opening 56 in the housing 40 until properly seated with respect to the underlying chip stage 54. One also positions a cell phone C on the cell phone receiver 51. Next, one activates the instrument 12 by means of the actuator button 66 of the user interface 68. When activated, the carriage 56 is positioned at the left end 62 of the linear guideway 58, with the magnet 60 underneath the wastewater sample well 16. The magnet 60 produces a magnetic field that captures the plurality of paramagnetic particles P in the wastewater well 16. This includes the nucleic acid fractions bound to those particles P.

Next the controller 42 causes the carriage 56 to move slowly along the guideway 58 from the left end 62 toward the right end 64 (note action arrow A in FIG. 3B). The speed on this movement may be on the order of 2-5 mm/sec to ensure that the paramagnetic particles P stay captured by the magnetic field. As the carriage 56 moves, the magnet 60 draws the paramagnetic particles P through the first communication channel 26 into the first isolation well 18. The immiscibility of the water in the wastewater sample well 16 in the oil in the first isolation well 18 acts as a barrier, allowing the selective passage of the paramagnetic particles P bound with the nucleic acid fractions through the communication channel 26, while preventing the passage of the water, cellular debris and extraction reagents/lysis buffer that are left behind in the wastewater sample well 16.

The carriage 56 continues its movement along the guideway 58 toward the second end 64 with the magnet 60 drawing the paramagnetic particles P further along through the second communication channel 28 into the wash well 20 where the nuclease-free water tends to wash any remaining aqueous solution, cellular debris and extraction reagents from the particles. The immiscibility of the oil from the first isolation well 18 with the water in the wash well 20 prevents the oil from passing with the particles P through the second communication channel 28.

As the carriage 56 moves further along through the third communication channel 30 to the second isolation well 22, the immiscibility of the water in the wash well 20 with the oil in the second isolation well 22 acts as another barrier, allowing the selective passage of the paramagnetic particles P bound with the nucleic acid fractions through the communication channel 30, while preventing the passage of the water, cellular debris and extraction reagents that are left behind in the wash well. As the carriage 56 continues moving in the direction of action arrow A, the particles P, with the nucleic acid fractions bound thereto, are displaced through the fourth communication channel 32 into the elution well 24. The immiscibility of the oil from the second isolation well 18 with the water in the elution well 24 prevents the oil from passing with the particles P through the fourth communication channel 32. At this point, the carriage 56 has reached the second or right end 64 of the linear guideway 58 with the resistive heating element 50 carried thereon in position to heat the LAMP reagents in the elution well 24 to a constant temperature of 65° C. for thirty minutes.

A system status light 70 of the user interface 68 may be activated by the controller 42 to indicate the active heating cycle. A second system status light 72 of the user interface may be activated by the controller 42 to indicate when the heating cycle is completed. The controller 42 may also activate the light source 48 during the heating cycle in order to illuminate the elution well 24. As should be appreciated, when the cell phone C is properly seated in the cell phone receiver 51, the lens L of the cell phone camera is positioned over the camera window 74 provided in the housing above the elution well 24. This allows one to easily and conveniently monitor and track any color change in the LAMP reagents in the elution well 24. Color change is indicative of the presence of nucleic acid fragments of the targeted pathogen in the wastewater sample.

### EXPERIMENTAL

### Materials and Methods

Chip fabrication and preparation. The chip was fabricated out of ⅛ in (3.175 mm) thick Polymethyl methacrylate (PMMA) sheets (McMaster-Carr, 8589K41) using a CO2 laser cutter (Universal Laser Systems, VersaLaser VLS3.50). The adhesive films (ThermoFisher Scientific, AB-1170) for the enclosing of the chambers were also cut using the laser cutter. The chips and adhesive films were designed in CorelDraw (version 15.2), where cutting and engraving lines were specified. Following the fabrication, the CEIDs were sprayed with 70% ethanol, wiped with Kimwipes and left to dry. Then, the chips and pressure sensitive adhesive films were aligned and bonded together using a film sealing paddle. The bonded CEIDs were kept inside a clean container for future use. The whole process for fabrication and preparation of each CEID took about 7 minutes.

The overall size of the chip or CEID is 50*127 mm, where the wash well is 5*10 mm (equal to 160 μL), and the oil and elution wells are 5*5 mm (equal to 2 drops or 80 μL). The sample well uses a 30*45 mm rectangle and a 30*20 mm triangle (total of 5.12 mL). Wells are connected by channels that converge from a width of 5 mm to 1.5 mm, with a height of 0.44 mm. While the wells were cut out of the PMMA sheet, the connection channels were fabricated using the engraving option of the laser cutter.

On-chip nucleic acid concentration and extraction. In the first step, the chip was loaded with the appropriate reagents. Briefly, 2 drops of silicone oil with a viscosity of 1000 cSt (1:2 mixing ratio of 50 cSt and 10000 cSt silicone oils (Sigma Aldrich, 378356 and 378402)) were added to each of the oil chambers, and 160 and 80 μL of nuclease-free water were added to the wash and elution wells, respectively. Next, 2 mL of wastewater sample was transferred to a tube and mixed with 3 mL of lysis buffer containing 4 M Guanidine Thiocyanate (GTC) (ThermoFisher, AM9422), and 10 mM 4-morpholinethanesulfonic acid (MES) sodium salt (Sigma Aldrich, M3671) dissolved in 1:1 v/v absolute ethanol/DI water and 0.1% v/v Tween 20 (Sigma Aldrich, P9416). Then, 60 μL of each of two different sizes of paramagnetic particles (PMPs) (Cytiva, Serasil-Mag™ #29357369 and #29357374), were added to the sample.

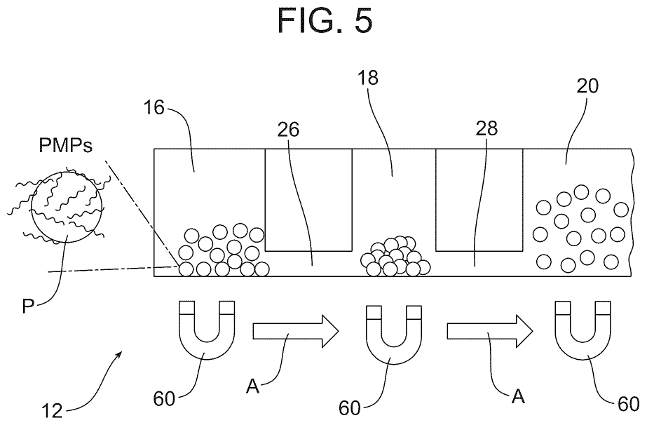

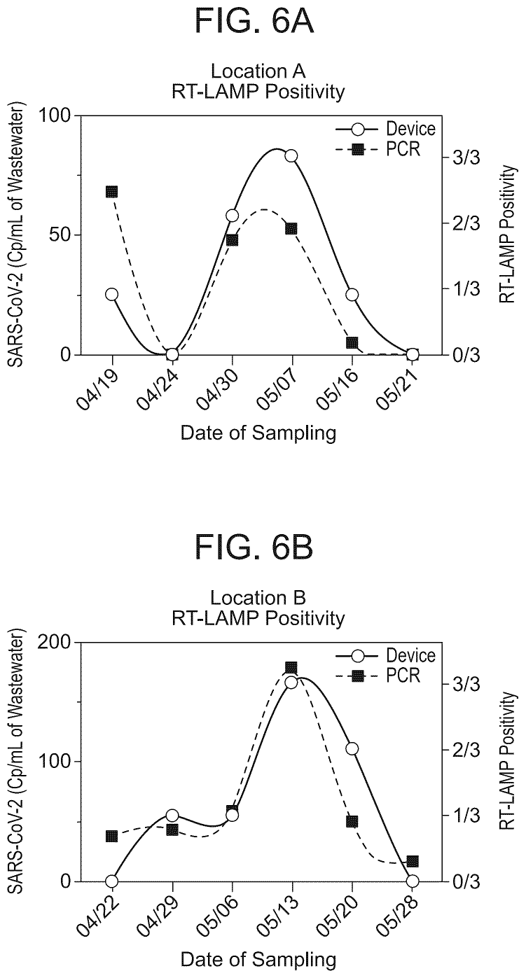

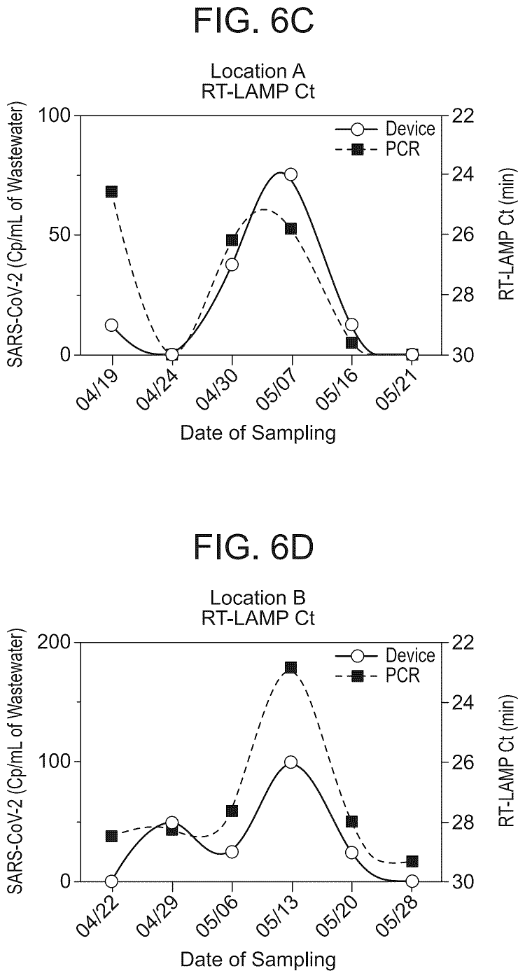

The tube was then inverted a few times to ensure the mixing of the reagents and PMPs. The mixture of sample, lysis buffer, and PMPs (total of 5.12 mL) was then loaded to the sample well. An external magnet (K&J Magnetics, D4X0DIA-N52) collected all the PMPs inside the sample well. The PMPs were then pulled through the series of wells by a simple linear manual movement of the magnet. While PMPs can move through oil, the interface between oil and aqueous buffers acted as a barrier to prevent flowing of the buffers, resulting in transfer of the PMPs from one aqueous phase to another via transport through the oil barrier (FIG. 5). Once in the elution well, the PMPs were mixed by pipetting up and down. The CEID was then placed on a hot plate at 65° C. for 5 minutes to ensure elution of nucleic acids. In the final step, the PMPs were separated using a magnet and the extracted nucleic acid was collected.

RT-qPCR assay. For the purposes of quality control and comparison, SARS-CoV-2 and CrAssphage nucleic acids were measured in all extracted samples from the CEID and ESP using RT-qPCR. CrAssphage is a bacteriophage that is abundantly found in wastewater samples and is used as an intrinsic positive control for this study. The N1 gene was used for the SARS-CoV-2 assay with a primer and probe listed in Table 1, as recommended by the CDC. The primer and probe sequences for CrAssphage are also listed in Table 1.

TABLE 1
RT-qPCR primers and probe for SARS-COV-2 and CrAssphage

| RT-qPCR | | |
|---|---|---|
| Assay | | Sequence (5′-3′) |
| SARS-COV-2 | Forward Primer | GACCCCAAAATCAGCGAAAT SEQ ID NO: 1 |
| N1 | Reverse Primer | TCTGGTTACTGCCAGTTGAATCTG SEQ ID NO: 2 |
| | Probe | FAM-ACCCCGCATTACGTTTGGTGGACC-MGB SEQ ID NO: 3 |
| CrAssphage | Forward Primer | CAGAAGTACAAACTCCTAAAAAACGTAGAG SEQ ID NO: 4 |
| | Reverse Primer | GATGACCAATAAACAAGCCATTAGC SEQ ID NO: 5 |
| | Probe | FAM-AATAACGATTTACGTGATGTAAC-MGB SEQ ID NO: 6 |

More specifically, for both SARS-CoV-2 and CrAssphage assays, the probes include a FAM fluorophore and MGB quencher. ThermoFisher synthesizes the primers and probes at a 60× concentration. In the reaction, the effective 1× concentration amounted to 900 nM for each primer and 250 nM for the probe. Each assay was carried out in a 20 μL reaction volume that included 10 μL of the sample, 5 μL of TaqMan 4× Fast Virus 1-Step Master Mix (Applied Biosystems, 4444434), 1 μL of primers and probes at a 20× concentration, and 4 μL of nuclease-free water (Growcells, NUPW100012). The one-step RT-qPCR reaction was performed using a LightCycler 480 II (Roche Diagnostics, 05015278001) with thermocycling steps including reverse transcription at 50° C. for 5 min, a hot 95° C. start for 20 s, followed by 50 cycles of 60° C. for 1 min and 95° C. for 20 s. The FAM fluorescence signal was measured in real-time.

For the SARS-CoV-2 assay, a positive control consisting of SARS-CoV-2 genomic RNA (NR-52508, Isolate USA-CA4/2020, BEI Resources) was added to a reaction well on the PCR plate. The RT-qPCR reaction for CrAssphage was confirmed on each plate using previously extracted samples that were known to contain CrAssphage. For both assays, the no template control (NTC) consisted of 10 μL of nuclease-free water. The quantification cycle (Cq) was determined by the 2^{nd} derivative algorithm, finding the point of inflection of the curve. In general, samples without amplification or a Cq value exceeding 40 were classified as negative. The resulting Cq was then converted to copies per reaction using a standard curve, created by serial 1:10 dilutions of SARS-CoV-2 (NR52350, Isolate USA-WA1/2020, BEI Resources). The absolute concentration of this stock was measured by BEI Resources using droplet digital PCR (ddPCR) and was equal to 3.4E8 Cp/mL. The correlation coefficient (r²) of the standard curve was 0.9992, with a slope of −3.3084 (FIG. S2), resulting in an amplification efficiency of 100.57%, in accordance with the MIQE guidelines.

Wastewater is a complex sample containing various substances that can inhibit the PCR reaction. The carryover of these substances to the extracted sample can lead to the incorrect measurement of the target⁴⁹. As a result, 1:3 dilutions of the extracted nucleic acid were quantified along with the undiluted sample. The resultant Cq from the diluted samples was compared with the undiluted sample to measure whether or not the amplification was inhibited (i.e., confirming whether the CEID successfully purified the pathogen nucleic acid from the inhibitory wastewater background).

RT-LAMP assay. We used colorimetric RT-LAMP as a less resource-intensive endpoint, as it only requires a constant temperature and visual detection. The SARS-CoV-2 RT-LAMP assay targets the nucleocapsid gene, with six primers, including forward, backward, forward inner, backward inner, loop forward, and loop backward primers. The sequences for all the LAMP primers are listed in Table 2.

TABLE 2
RT-LAMP Primers for SARS-COV-2

| RT-LAMP | | |
|---|---|---|
| Assay | | Sequence (5′-3′) |
| SARS-COV-2 | Forward | AACACAAGCTTTCGGCAG SEQ ID NO: 7 |
| Nucleocapsid | Primer | |
| | Backward | GAAATTTGGATCTTTGTCATCC SEQ ID NO: 8 |
| | Primer | |
| | Forward | TGCGGCCAATGTTTGTAATCAGCCAAGGAAATTTTGGGGAC |
| | Inner | SEQ ID NO: 9 |
| | Primer | |
| | Backward | CGCATTGGCATGGAAGTCACTTTGATGGCACCTGTGTAG |
| | Inner | SEQ ID NO: 10 |
| | Primer | |
| | Loop | TTCCTTGTCTGATTAGTTC SEQ ID NO: 11 |
| | Forward | |
| | Primer | |
| | Loop | ACCTTCGGGAACGTGGTT SEQ ID NO: 12 |
| | Backward | |
| | Primer | |

The primers are designed and evaluated by the New England Biolabs LAMP Primer Design Tool (lamp.neb.com) and ordered through custom oligos from ThermoFisher. Primers were received lyophilized and rehydrated to 100 mM using nuclease-free water. For a final 1× concentration, the concentration of each primer included: 200 nM for forward and backward, 400 nM for loop forward and loop backward, and 1600 nM for forward and backward inner primers. All assays were performed in a total of 25 μL reaction volume, consisting of 10 μL of sample, 12.5 μL of WarmStart Colorimetric LAMP 2× Master Mix with UDG (NEB, M1804L), and 2.5 μL of 10× primer mix. SARS-CoV-2 genomic RNA (NR-52508, Isolate USA-CA4/2020, BEI Resources) was added to one of the reaction wells as the positive control. For the no template control (NTC), nuclease-free water was added to the reaction well. In the case of a positive sample, the reaction color changed from pink to yellow, while a negative sample stayed pink throughout the reaction.

Off-chip RT-LAMP. The standard curve for the SARS-CoV-2 assay was performed off-chip, on a plate reader (Molecular Devices, 1-2100-0548), to measure the sensitivity and specificity of the colorimetric RT-LAMP. As a result, the RT-LAMP reaction was initially performed inside a 96-well plate at 65° C. for 60 minutes using a plate reader to ensure an accurate comparison with the standard curve. The color change of each well was measured at 1 min intervals using absorbance at 480 and 560 nm wavelengths. In the case of a positive well, the absorbance at 480 nm decreased (the pink color), and the absorbance at 560 nm increased (the yellow color). The time that the ratio of the absorbance of the two colors increases more than 10% of the average of previous 10 points was considered the RT-LAMP crossing time (Ct). All reactions were performed in triplicate to ensure repeatability.

On-chip RT-LAMP. The on-chip RT-LAMP was performed inside the wells located at the upper part of the CEID. The wells were 3.5 mm in diameter. The extracted nucleic acid, the master mix, and primers were mixed inside the wells and covered with a drop of silicon oil to prevent evaporation and aerosol contamination. The reaction was performed in triplicate, along with positive and no template (negative) controls. The CEID was then placed on a hot plate at 65° C. for 30 minutes. Next, the CEID was removed from the hot plate and analyzed for color change.

Real-time analysis of on-chip RT-LAMP. A smartphone was used to take time-lapse images of the on-chip RT-LAMP reaction in 1 min intervals. For consistency of the light in images, a cardboard box was placed on top of the hotplate and an LED was used to light up the box. The resulting images were then analyzed to measure crossing time (Ct) using ImageJ. Briefly, 30 images are stacked together, and after splitting the RGB channels, the mean gray value was measured in the regions of interest in the green channel. A crossing time (Ct) was determined when the green channel increased more than 10% of the rolling average calculated from the previous 10 timepoints.

Contamination carry-over and PMPs recovery measurement. The contamination carry-over from one well to the other was measured using the fluorescent dye acridine orange (ThermoFisher Scientific, A1301) as the model contaminant, due to its stable fluorescence across the various buffers utilized in this study. In brief, acridine orange was dissolved in the combination of lysis, sample, and PMPs at a concentration of 10 mg/mL. PMPs were then extracted and transferred to the next well. PMPs were then mixed with a pipette, captured on a magnet and the elution buffer was collected. The elution buffer fluorescent intensity was measured using the plate reader with excitation at 490 nm and emission at 520 nm. A standard curve was obtained by measuring the fluorescent intensity of serial dilutions with known concentrations of acridine orange. The amount of carry-over was determined by fitting the fluorescent intensity of the elution buffer to the standard curve. Moreover, the effect of carry-over contamination is studied on both RT-qPCR and RT-LAMP, to ensure that CEID has minimal carry-over that does not inhibit the nucleic acid amplification step. PMPs' recovery was also measured using their autofluorescence at 635 nm. A standard curve was formed to measure the concentration of PMPs in solution.

Wastewater sample collection. Effluent wastewater samples from a local hospital were collected from a manhole connected to the building's sewage system. A passive sampler, also known as a Moore swab, was used, in which five pieces of gauze pads (ThermoFisher Scientific, Catalog No. 13-761-52) were tied together and suspended in the wastewater flow using a string. The Moore swab was collected after 24 hours and transferred to the lab inside a sealed plastic bag. The swab was then squeezed to extract the entrapped liquid and particulate matter and transferred into a 50 mL conical tube for further analysis. Moore swab is a simple, yet effective sample collection method and has been shown to perform equivalently to composite sampling and to outperform grab sampling. Additionally, influent composite samples were collected at a local wastewater treatment plant (WWTP) using an autosampler over 24 hours. While the Moore swab represents a simple and instrument-free approach to sample collection, the autosampler is recognized as the gold standard in wastewater surveillance. In this study, we employed both techniques to demonstrate the compatibility of our CEID with these diverse sampling methods.

### Results and Discussion

CEID chip design characterization and optimization. We designed the assay to work with open-source, non-proprietary reagents and fabricated the CEID or chip from readily available, affordable materials. The reagents used in this chip build upon our previous published works, in which we used GTC-based lysis buffer and silica coated PMPs to capture nucleic acids. Silica coated PMPs from different vendors were tested previously, and SeraSil-Mag™ PMPs from Cytiva were chosen due to their high magnetic responsiveness and binding capacity. Optimal performance was defined as the point where the chosen PMPs exhibited both ease of movement through channels and buffers as well as maximized nucleic acid capture. To optimize the amount of PMPs for optimal performance, wastewater was extracted on chip with five different PMPs volumes (5, 10, 20, 60, 120 μL). The purified nucleic acids were measured by qPCR for RNA (SARS-CoV-2) and DNA (CrAssphage) targets, as well as Qubit for RNA and DNA. None of the PMP volumes occluded the channels (height of 440 μm) during the magnetic transfer in the channels and there was no sign of residual PMPs in each well. Increasing the PMPs volume increased the yield of both DNA and RNA. However, both qPCR and Qubit measurements showed there was not a significant difference between 60 and 120 μL of PMPs. Compared with 40 μL of PMPs, the extracted nucleic acids were significantly higher when 60 μL of PMPs were used. As a result, 60 μL of PMPs was chosen for further experiments.

The IFAST technology relies on the dominance of surface tension forces over other forces (e.g., gravity force) to establish and retain a barrier between different buffers. The Bond number (Bo=ΔμgL²/γ) can be used to explain the relative effect of gravitational forces to surface tension forces, where ρ is the density of the liquid, g is the acceleration of gravity, L is the characteristic length scale, and γ is the surface tension. For a system where surface tension forces are strong enough to minimize the influence of gravity, the Bond number needs to be much smaller than 1. As Bond number is proportional to L², decreasing the dimensions quickly shifts Bo into a regime dominated by surface tension. As a result, in CEID, the height of the connection channels between wells are minimized to stabilize the interfaces, while allowing the PMPs to pass. As connection channels are fabricated through laser engraving, the number of engraving passes determines the channel heights. We tested different repetitions of engravings ranging from 1 to 5 passes and measured the resulting channel height (Table 3).

TABLE 3
Resulting channel height for different passes of laser engraving

| Number of | Channel Height | Require manual correction |
|---|---|---|
| Engraving Passes | (μm) | to move PMPs |
| 2 | 150 | Yes |
| 3 | 300 | Yes |
| 4 | 440 | No |
| 5 | 550 | No |

The experiments have shown that the resulting channel heights are small enough to have a stable interface between the two immiscible phases. Moreover, the PMPs can be moved throughout this broad range of channel heights. However, for channel heights around or smaller than 300 μm, some of the PMPs may be left behind and the magnet require manual correction to successfully transfer all the PMPs across each oil barrier. As a result, to prevent PMPs loss and occlusion, we selected an optimized channel height of 440 μm, equivalent to 4 engraving passes.

On the other hand, the IFAST concept depends on a stable immiscible phase barrier that permits the passage of PMP-bound nucleic acids in a magnetic field while minimizing lysate carryover. As a result, the interfacial energy between the lysate and oil plays a key role in determining a stable barrier between the two wells after the passage of the PMPs. The ability of the lysate to pinch and recede after passage of the PMPs is related to the interfacial/surface energy associated with the contact between the lysate and the surface. According to the Dupre equation, the work of adhesion per unit area (w_{adh}) is measured by the decrease in the surface/lysate interface and increase in the surface/oil and lysate/oil interface:

$${w}_{adh} = {γ}_{LO} + {γ}_{SO} - {γ}_{SL} \qquad ( 1 )$$

where γ_{LO} is the interfacial energy between the lysate and oil, γ_{SO} is the oil surface energy, and γ_{SL} is the lysate surface energy. If this work is smaller than the lysate/oil interfacial energy, the high interfacial energy will pinch off the lysate. On the other hand, if this work is larger than the lysate/oil interfacial energy, the PMPs will drag the lysate into the oil phase and eventually connect the lysate well to the wash well. The balance of these energies can be further explained by the Young's Equation for a droplet of lysate on a surface covered with oil:

$${γ}_{SL} - {γ}_{SO} + {γ}_{LO} cos θ = 0 \qquad ( 2 )$$

where θ is contact angle of the lysate on a surface covered with oil. Combining Equations 1 and 2 results in:

$$cos θ = \frac{{w}_{adh}}{{γ}_{LO}} - 1 \qquad ( 3 )$$

For a stable regime, where the lysate pinches off and PMPs move to the oil well with minimal carry-over, w_{adh} must be less than γ_{LO}, requiring the cosθ to be negative. This concept enables the prediction of the stable interface with a simple contact angle measurement where θ>90°. In this work, we have measured the contact angle of the lysate on the pressure sensitive film covered with silicone oil. The contact angle is about 135°, which ensures the minimal carry-over of the lysate into the following wells. As expected, we found that the lysate pinches off and recedes back to the lysate well after PMPs move to the oil well.

Moreover, we have also tested a variety of silicone oils with viscosities ranging from 50 to 10000 cSt. Since all these silicone oils results in a contact angle of more than 90°, the lysate/oil interface is stable. However, when filling the wells, lower viscosity oils fill up the channels faster and quickly move to the neighboring wells, resulting in a depletion of oil in the oil well. As a result, there is a need to refill the oil well after addition of sample and reagents, which is not ideal. On the other hand, higher viscosity oils result in a very slow movement of the PMPs and might require manual correction to move the PMPs. This result can also be explained through the Stokes law for a moving particle in a fluid; u=F_{mag}/6πrη, where η is the viscosity of the fluid. Based on these results, we chose silicone oil with a viscosity of 1000 cSt as our immiscible phase.

A key determinant of CEID performance is the loss of PMPs during transfer. To quantify this, three independent operators executed the CEID protocol, and the residual PMPs volume was measured. On average, 1.3 μL of beads were lost during transfer, corresponding to a PMP recovery of 97.8%.

Since wastewater is a complex matrix containing numerous inhibitory molecules, it is crucial to evaluate CEID's effectiveness in depleting these inhibitors. After the optimization of chip geometry and oil properties, we have measured the amount of carry-over from one well to the other using a fluorescent molecule (acridine orange) as the model contaminant. Our results show that on average, 0.86% of the acridine orange was carried over from one well to the next well during the PMP extraction. By implementing a wash step, only 0.0074% of the lysate contamination (wastewater and lysis buffer) was present in the elution well.

To understand whether this amount of contamination inhibited the amplification step, we measured the effect of different concentrations of sample contamination on RT-qPCR and RT-LAMP using three different wastewater samples. These wastewater samples come from various sources with variable turbidity and levels of inhibitory molecules. We found that RT-qPCR is completely inhibited for lysate contamination concentrations of higher than 1% in the elution buffer. However, RT-LAMP showed some positive results for contamination concentrations of around 5%, although the Ct dramatically increased, leading to a reduction in sensitivity. As mentioned by others, RT-LAMP is more resistant to inhibition compared to RT-qPCR. Our results showed that the CEID contamination carry-over did not inhibit RT-qPCR and RT-LAMP. While we have tested 3 different wastewater samples with varying levels of turbidity, it is important to note that each wastewater sample is unique, and some might have higher concentrations of inhibitory molecules that can affect the amplification step.

On-chip nucleic acid extraction. We further evaluated the performance of the CEID for the extraction of SARS-CoV-2 from wastewater. Wastewater samples were spiked with heat-inactivated SARS-CoV-2 at different concentrations and extracted using three different methods; CEID, ESP (refer to the experimental section), and Qiagen AllPrep DNA/RNA Micro Kit, which is commonly used for extraction of DNA/RNA from wastewater (a “gold standard” in this case). The spiked concentrations ranged from 10000 to 100 copies per mL (Cp/mL) of wastewater. After extraction using these methods, SAR-CoV-2 was quantified using RT-qPCR on the elution buffer from each of the methods. We found that the on-chip extraction resulted in higher SARS-CoV-2 copies per elution compared to ESP and Qiagen at different spiked concentrations. On-chip and ESP extractions successfully detected SARS-CoV-2 at concentrations as low as 100 Cp/mL, whereas the Qiagen extraction method failed to extract the virus at this concentration. Moreover, the variations between replicates were generally smaller for the on-chip extraction, leading to less errors in measurement.

Colorimetric RT-LAMP limit of detection for SARS-CoV-2. In the first step, the limit of detection (LoD) of colorimetric RT-LAMP for SARS-CoV-2 was measured using serial dilutions of spiked samples. The serial dilutions were made by spiking known amounts of SARS-CoV-2 genomic RNA into a background of extracted nucleic acids from a negative wastewater sample (i.e., the original wastewater did not show any non-specific amplification, confirmed by RT-qPCR and RT-LAMP). Interestingly, our data showed that, unlike RT-qPCR, the presence of background nucleic acids improved the RT-LAMP assay by decreasing the Ct. Other studies reported the same effect, where carrier RNA (background nucleic acids) was used to improve the RT-LAMP. In our case, wastewater contained a high concentration of RNA, which can work as a carrier RNA to improve amplification efficiency. As a result, spiked dilutions were prepared in extracted wastewater, rather than nuclease-free water. These experiments were performed off-chip, on a 96-well plate and inside a plate reader, to accurately measure the RT-LAMP Ct.

The amplification curves were determined using the ratio of absorbance at 560 and 480 nm. This ratio can quantify the amount of color change from pink to yellow. RT-LAMP was able to detect SARS-CoV-2 down to 5 copies per reaction. However, due to the presence of 6 primers in the RT-LAMP reaction, primer dimers can form, and non-specific amplification can happen at later times in the reaction. In our case, one of the replicates of our negative control (0 copies per reaction) started to show amplification at around 45 minutes. New England Biolabs suggests running the RT-LAMP for 30 minutes. By choosing a cut-off time of 30 minutes, the off-chip assay limit of detection was measured to be somewhere between 10-100 copies per reaction, which agrees with prior works. At high concentrations of the target, we found that the RT-LAMP Ct correlated with the number of copies per reaction (R²=0.96), where higher concentrations lead to a faster color change. However, at concentrations lower than 100 copies per reaction, a similar correlation did not hold between the Ct time and the target concentration, and the variations between replicates were high, leading to a loss of accuracy. This suggested that RT-LAMP can be used as a qualitative method for concentrations lower than 100 copies per reaction.

In the next step, we performed RT-LAMP on our chip wells (on-chip RT-LAMP) and analyzed the color change in real-time using a phone camera (iPhone 13, Apple). Our previous experiences with SARS-CoV-2 detection in wastewater showed that the copies per reaction are usually in the range of 0-500. Therefore, for on-chip RT-LAMP, we explored the LoD using lower concentrations of SARS-CoV-2 (0-400 copies per reaction). While the RT-LAMP Ct correlated with the SARS-CoV-2 concentration (R²=0.78), the high variation between replicates made it difficult to use on-chip RT-LAMP for quantitative measurements at low concentrations. Based on replicate positivity at 50 or more copies per reaction, 3 out 3 replicates were positive. At 25 and 12 copies per reaction 2 and 1 replicates were positive, respectively. This agreed with the off-chip RT-LAMP, which showed an LoD between 10-100. The negative control (0 copies per reaction) did not show a sign of positivity at 30 minutes, supporting the use of a 30 minute cut off for our assay. It should be noted that the greater variability seen at the lowest concentration is not an inherent difference between the on-chip and off-chip assays; it simply arises from the different negative Ct we applied (60 min for the off-chip assay and 30 min for the on-chip assay).

Analysis of spiked wastewater samples with integrated CEID. Wastewater samples mixed with lysis buffer and PMPs were loaded into the chip and a magnet dragged PMPs through oil and buffers leading to the elution of nucleic acids in nuclease-free water. In the last step, the extracted nucleic acids along with positive and negative controls were mixed with colorimetric RT-LAMP mastermix in the assigned wells. The CEID was placed on the hot plate at 65° C. The negative and positive wastewater samples were visibly distinguished by the color change. The whole process took 40 minutes, including 5 min for extraction, 5 min for elution, and 30 min for detection.

To study the performance of the integrated CEID, wastewater samples from different locations were spiked with varying amounts of heat-inactivated SARS-CoV-2. Nucleic acids were then extracted, and SARS-CoV-2 was detected using on-chip colorimetric RT-LAMP. Also, the concentration of SARS-CoV-2 was measured using ESP (our standard lab method) and RT-qPCR. As the concentration of SARS-CoV-2 increased, more of the replicates became positive. There was not a significant difference in the concentration of SARS-CoV-2 between 0 and 1 RT-LAMP positive replicates. However, for wastewater samples with 2 or 3 RT-LAMP positive replicates, there was a significant difference between the RT-qPCR measured concentrations. As a result, wastewater samples with 0 or 1 positive replicates are considered negative or very low concentration samples. Moreover, the RT-LAMP Ct was plotted against SARS-CoV-2 concentration in wastewater, which showed a relatively low R2 value (0.48), due to the low copies per reaction concentration (FIG. S8B). Therefore, we used the RT-LAMP positivity to determine the limit of detection for the integrated CEID which was 113 Cp/mL of wastewater.

Wastewater surveillance of SARS-CoV-2 using the integrated CEID. The CEID was used to monitor the presence of SARS-CoV-2 over 6 weeks in the wastewater samples from two different locations, a wastewater treatment plant, and a hospital sewage manhole. The samples were processed by both ESP and the integrated CEID. Our standard lab method included ESP sample processing and RT-qPCR to measure the concentration of SARS-CoV-2 in wastewater. The results were then reported in copies per mL of wastewater on the left Y-axis in FIG. 5A-D. For the integrated CEID both the RT-LAMP replicate positivity (out of 3 replicates) and RT-LAMP Ct (in minutes) were reported. As shown in FIGS. 5A and 5B, the trend of SARS-CoV-2 concentration was also seen in the replicate positivity (Kendall's Tau value of 0.64 and 0.79, which are considered “high correlation”). As an example, for location A, RT-qPCR results from samples on 04/30 and 05/07 indicated an increase in the concentration of SARS-CoV-2 which agreed with higher RT-LAMP replicate positivity, as well as lower RT-LAMP Ct. The RT-LAMP Ct was also highly correlated with the SARS-CoV-2 concentrations as measured by RT-qPCR (shown by Kendall's Tau values of −0.64 for both locations). Based on these results, CEID measured SARS-CoV-2 in wastewater in a semi-quantitative manner and indicated SARS-CoV-2 concentration trends with replicate positivity, as well as RT-LAMP time to positivity.

Wastewater-based epidemiology or WBE offers a powerful tool for monitoring infectious diseases and identifying emerging hotspots by analyzing wastewater for genetic material from pathogens like viruses or bacteria. WBE provides a cost-effective and non-invasive way to assess the health of entire communities without relying on individual testing. This is particularly valuable in regions with limited healthcare infrastructure or resources, where access to medical facilities may be restricted, and traditional disease surveillance is challenging. Moreover, these low resource settings can serve as the breeding ground for emerging pathogens, which emphasizes the importance of adapting WBE in these regions. In LMICs and rural settings, WBE can uncover previously undetected disease hotspots, enabling targeted interventions in areas that might otherwise be overlooked. However, WBE adaption in LMICs and rural areas is hindered due to the need for a centralized lab with infrastructure, expensive instruments, and skilled personnel. As a result, there is a need for simplified and easy-to-use technologies to analyze wastewater samples for pathogens. A point-of-use device, that can process the wastewater sample at the point-of-sample collection, can greatly increase the capacity of WBE in LMICs and rural areas. By leveraging local wastewater systems, this approach offers a scalable and practical solution for global health monitoring, particularly in underserved communities.

In this work, we have successfully developed a system (CEIS with the potential for rapid, and cost-effective point-of-use nucleic acid concentration, extraction, and identification from wastewater. The CEIS uses non-proprietary, open-source reagents and affordable materials to perform the concentration and extraction of nucleic acid from wastewater samples. The target nucleic acids are then identified using a colorimetric RT-LAMP assay, where the final results can be visualized through a color change. The total per sample cost is about $11 for the CEIS, with the RT-LAMP mastermix accounting for more than 60% of this cost. With further developments, the cost for the mastermix can be lowered by using bulk order of the mastermix from NEB or developing an in-house mastermix recipe. Moreover, the CEIS only requires a hot plate at 65° C., which can be reached using a battery-powered PTC heating element. As a comparison, the ESP and Qiagen methods cost about $34 and $61 per sample respectively, and require high speed centrifuge and PCR machine, which are expensive, bulky, and not available in many parts of the world. In terms of time, the CEIS takes about 40 minutes, of which only 5 minutes is hands-on time. As a comparison, ESP and Qiagen requires around 3 hours to complete, with 35 and 55 minutes hands-on time, respectively. The CEIS effectively measured the presence of SARS-CoV-2 in wastewater samples from a hospital sewage stream and a wastewater treatment plant over the course of 6 weeks. The results showed good correlation with our standard lab approach (i.e., ESP and RT-qPCR) and CEIS. While CEIS is not able to quantify the amount of SARS-CoV-2, it can reveal the trends of pathogen in wastewater in a semi-quantitative manner. CEIS has the potential to expand to other infectious diseases by implementing RT-LAMP assays for other pathogens such as influenza or RSV.

Although the system 10, instrument 12 and related method of this disclosure have been illustratively described and presented by way of specific exemplary embodiments, and examples thereof, it is evident that many alternatives, modifications, or/and variations, thereof, will be apparent to those skilled in the art. For example, the chip 12 could include one or more additional wash wells 20 and one or more additional isolation buffer wells 22 between the sample well 16 and the elution well 24. Accordingly, it is intended that all such alternatives, modifications, or/and variations, fall within the spirit of, and are encompassed by, the broad scope of the appended claims.

What is claimed:

1. A concentration, extraction and identification system (CEIS) for microbiological analysis of a biological sample, comprising:
a plurality of paramagnetic particles adapted to bind to a nucleic acid fraction of a targeted biological pathogen;
a microfluidic chip including (a) a biological sample well adapted to receive a mixture of the biological sample, the plurality of paramagnetic particles and a lysis buffer, (b) a first isolation buffer well downstream from the biological sample well, (c) a wash well downstream from the first isolation buffer well, (d) a second isolation buffer well downstream from the wash well, and (e) an elution well downstream from the second isolation buffer well; and
a microfluidic chip reading instrument including a housing carrying (a) a microfluidic chip receiver adapted to hold the microfluidic chip and (b) a magnet and actuator adapted to displace the plurality of paramagnetic particles from the biological sample well through the first isolation buffer well, the wash well, and the second isolation buffer well to the elution well.

2. The CEIS of claim 1, wherein the microfluidic chip reading instrument further includes a heating element adapted to heat amplification reagents and the plurality of paramagnetic particles when in the elution well.

3. The CEIS of claim 2, further including a controller carried on the housing, wherein the controller is adapted to control the actuator and the heating element.

4. The CEIS of claim 3, further including a power source carried on the housing, wherein the power source is adapted for powering the controller, the actuator and the heating element.

5. The CEIS of claim 4, wherein the housing further includes a cell phone receiver adapted to receive and hold a cell phone.

6. The CEIS of claim 5, wherein the housing further includes a camera window oriented to be positioned between a camera lens on the cell phone and the elution well of the microfluidic chip when the cell phone is properly seated in the cell phone receiver and the microfluidic chip is properly seated in the microfluidic chip receiver.

7. The CEIS of claim 6, further including a system status indicator carried on the housing, said controller being adapted to control the system status indicator.

8. The CEIS of claim 7, further including an actuator switch carried on the housing.

9. A microfluidic chip reading instrument adapted to receive and hold a microfluidic chip for concentration, extraction and identification of a nucleic acid fraction of a targeted biological pathogen, the microfluidic chip reading instrument comprising:
a housing including (a) a microfluidic chip receiver adapted to receive and hold the microfluidic chip and (b) a cell phone receiver adapted to receive and hold a cell phone.

10. The microfluidic chip reading instrument of claim 9, further including a magnet and actuator carried on the housing, said magnet and actuator being adapted to displace a plurality of paramagnetic particles between a plurality of wells in the microfluidic chip.

11. The microfluidic chip reading instrument of claim 10, further including a heating element carried on the housing, said heating element being adapted to heat amplification reagents and the plurality of paramagnetic particles in an elution well in the microfluidic chip.

12. The microfluidic chip reading instrument of claim 11, further including a controller carried on the housing, wherein the controller is adapted to control the actuator and the heating element.

13. The microfluidic chip reading instrument of claim 12, further including a power source carried on the housing, wherein the power source is adapted for powering the controller, the actuator and the heating element.

14. The microfluidic chip reading instrument of claim 13, wherein the housing further includes a camera window oriented to be positioned between a camera lens on the cell phone and the elution well in the microfluidic chip when the cell phone is properly seated in the cell phone receiver and the microfluidic chip is properly seated in the microfluidic chip receiver.

15. The microfluidic chip reading instrument of claim 14, further including (a) a light source adapted to illuminate the elution well in the microfluidic chip, (b) a system status indicator carried on the housing, and (c) an actuator switch carried on the housing, said controller being adapted to control the light source and the system status indicator.

16. A microfluidic chip reading instrument adapted to receive and hold a microfluidic chip for concentration, extraction and identification of a nucleic acid fraction of a targeted biological pathogen, the microfluidic chip reading instrument comprising:
a housing including a microfluidic chip receiver adapted to receive and hold the microfluidic chip; and
a magnet and actuator carried on the housing, said magnet and actuator being adapted to displace a plurality of paramagnetic particles between a plurality of wells in the microfluidic chip.

17. The microfluidic chip reading instrument of claim 16, further including a heating element carried on the housing, said heating element being adapted to heat amplification reagents and the plurality of paramagnetic particles in an elution well in the microfluidic chip.

18. The microfluidic chip reading instrument of claim 17, further including a controller carried on the housing, wherein the controller is adapted to control the actuator and the heating element.

19. The microfluidic chip reading instrument of claim 18, further including a power source carried on the housing, wherein the power source is adapted for powering the controller, the actuator and the heating element.

20. The microfluidic chip reading instrument of claim 19, wherein the housing further includes a camera window oriented to be positioned between a camera lens on the cell phone and the elution well in the microfluidic chip when the cell phone is properly seated in the cell phone receiver and the microfluidic chip is properly seated in the microfluidic chip receiver.

21. The microfluidic chip reading instrument of claim 20, further including (a) a light source adapted to illuminate the elution well in the microfluidic chip, (b) a system status indicator carried on the housing, and (c) an actuator switch carried on the housing, said controller being adapted to control the light source and the system status indicator.


SEQUENCE LISTING (12 sequences)

SEQ ID NO: 1 - RNA, 20 nt, synthetic construct
  source 1..20: mol_type = other RNA
gaccccaaaatcagcgaaat

SEQ ID NO: 2 - RNA, 24 nt, synthetic construct
  source 1..24: mol_type = other RNA
tctggttactgccagttgaatctg

SEQ ID NO: 3 - RNA, 24 nt, synthetic construct
  source 1..24: mol_type = other RNA
accccgcattacgtttggtggacc

SEQ ID NO: 4 - RNA, 30 nt, synthetic construct
  source 1..30: mol_type = other RNA
cagaagtacaaactcctaaaaaacgtagag

SEQ ID NO: 5 - RNA, 25 nt, synthetic construct
  source 1..25: mol_type = other RNA
gatgaccaataaacaagccattagc

SEQ ID NO: 6 - RNA, 23 nt, synthetic construct
  source 1..23: mol_type = other RNA
aataacgatttacgtgatgtaac

SEQ ID NO: 7 - RNA, 18 nt, synthetic construct
  source 1..18: mol_type = other RNA
aacacaagctttcggcag

SEQ ID NO: 8 - RNA, 22 nt, synthetic construct
  source 1..22: mol_type = other RNA
gaaatttggatctttgtcatcc

SEQ ID NO: 9 - RNA, 41 nt, synthetic construct
  source 1..41: mol_type = other RNA
tgcggccaatgtttgtaatcagccaaggaaattttggggac

SEQ ID NO: 10 - RNA, 39 nt, synthetic construct
  source 1..39: mol_type = other RNA
cgcattggcatggaagtcactttgatggcacctgtgtag

SEQ ID NO: 11 - RNA, 19 nt, synthetic construct
  source 1..19: mol_type = other RNA
ttccttgtctgattagttc

SEQ ID NO: 12 - RNA, 18 nt, synthetic construct
  source 1..18: mol_type = other RNA
accttcgggaacgtggtt